(19) United States
(12) Patent Application Publication
(10) Pub. No.: US 2012/0202047 A1
(43) Pub. Date: Aug. 9, 2012

(54) NANO-COATINGS FOR ARTICLES

(75) Inventors: John C. Welch, Spring, TX (US); Soma Chakraborty, Houston, TX (US)

(73) Assignee: BAKER HUGHES INCORPORATED, Houston, TX (US)

(21) Appl. No.: 13/022,047

(22) Filed: Feb. 7, 2011

(51) Int. Cl. B32B 5/16; B05D 1/36; B05D 3/12; B82Y 40/00; B82Y 30/00

(52) U.S. Cl. 428/323; 428/335; 427/402; 427/240; 427/407.1; 428/447; 428/425.5; 428/423.1; 428/704; 428/450; 428/457; 428/521; 428/522; 428/524; 428/412; 428/411.1; 977/742; 977/734; 977/775; 977/902

(57) ABSTRACT

A nano-coating comprises multiple alternating layers of a first layer comprising a first nanoparticle having an aspect ratio greater than or equal to 10 and having a positive or negative charge, and a second layer comprising a second nanoparticle having an aspect ratio greater than or equal to 10 and having a positive or negative charge opposite that of the first nanoparticle, wherein the nano-coating is disposed on a surface of a substrate. An article comprising the nano-coating, and a method of forming the nano-coating, are each disclosed.

### BACKGROUND OF THE INVENTION

A downhole environment such as, for example, an oil or gas well in an oilfield or undersea environment, a gas sequestration well, a geothermal borehole, or other such environment, may expose equipment used downhole, such as packers, blow out preventers, drilling motor, drilling bit, and the like, to conditions which may affect the integrity or performance of the element and tools.

Where the article is an element having a rubber or plastic part or coating, downhole conditions may cause, for example, swelling by uptake of hydrocarbon oil, water or brine, or other materials found in such environments, and which can thereby weaken the structural integrity of the element or cause the element to have poor dimensional stability, resulting in difficulty in placing, activating, or removing the element. Likewise, where the element includes metallic components, these components may be exposed to harsh, corrosive conditions due to the presence of materials such as hydrogen sulfide and brine, which may be found in some downhole environments.

Protective coatings are therefore desirable on such downhole elements, particularly coatings having improved barrier properties to resist exposure to a variety of different environmental conditions and materials found in downhole environments.

### SUMMARY

The above and other deficiencies of the prior art are overcome by, in an embodiment, a nano-coating comprising multiple alternating layers of a first layer comprising a first nanoparticle having an aspect ratio greater than or equal to 10 and having a positive or negative charge, and a second layer comprising a second nanoparticle having an aspect ratio greater than or equal to 10 and having a positive or negative charge opposite that of the first nanoparticle, wherein the nano-coating is disposed on a surface of a substrate.

In another embodiment, a nano-coating for an article comprises multiple alternating layers of a layer comprising positively charged graphene particles having an aspect ratio greater than or equal to 10, and a layer comprising negatively charged graphene particles having an aspect ratio greater than or equal to 10, wherein the nano-coating is disposed on a surface of the article.

In another embodiment, a method of forming a nano-coating on an article comprises depositing multiple alternating layers of a first layer comprising a first nanoparticle having an aspect ratio greater than or equal to 10 and having a positive or negative charge; and a second layer comprising a second nanoparticle having an aspect ratio greater than or equal to 10 and having a positive or negative charge opposite that of the first nanoparticle, on a surface of the first layer opposite the substrate.

### BRIEF DESCRIPTION OF THE DRAWINGS

FIG. 1A is a cross-sectional representation of a negatively charged nanoparticle, and FIG. 1B is a cross-sectional representation of a positively charged nanoparticle;

FIG. 2A to 2E is a series of cross-sectional structures showing formation of an exemplary multilayered nanoparticle layer;

FIG. 3 is a sectional view of an exemplary embodiment of a substrate with a multilayered nano-coating and a surface layer.

### DETAILED DESCRIPTION OF THE INVENTION

Disclosed herein is a novel nano-coating of multiple alternating layers of oppositely charged nanoparticles. The nano-coating comprises a nanoparticle possessing high aspect ratio (>10) and accompanying high surface area. In embodiments, the nano-coating may include multiple layers of a nanoparticle, where the nanoparticles in each layer have a positive or negative charge or are derivatized to include a functional group having a positive or negative charge, alternating from one layer to the next. More than one nanoparticle may be used. The nano-coating comprises at least 20 such alternating layers of positively charged nanoparticles and negatively charged nanoparticles.

The nano-coating comprises a nanoparticle possessing high aspect ratio and high surface area. Nanoparticles may include, for example, nano-scale particles of materials such as nanographite, graphenes including nanographene, graphene oxide, fullerenes such as C₆₀, C₇₀, C₇₆, and the like, nanotubes including single and multi-wall carbon nanotubes, doped nanotubes, metallic nanotubes, and functionalized derivatives of these; nanodiamonds; nanoclays; polyorganosilsesquioxane (POSS) derivatives having defined closed or open cage structures; and the like. Combinations comprising at least one of the following may be used. Preferred nanoparticles include graphenes.

In an embodiment, the nanoparticle may be coated with a metal coating such as Ni, Pd, Fe, Pt, and the like, or an alloy comprising at least one of the foregoing.

The nanoparticles can also be blended in with other, more common filler particles such as carbon black, mica, clays such as e.g., montmorillonite clays, silicates, and the like, and combinations thereof.

The nanoparticles may have an average particle size (largest average dimension) of e.g., less than 1 micrometer (μm), and more specifically a largest average dimension less than or equal to 500 nanometer (nm), and still more specifically less than or equal to 250 nm, where particle sizes of greater than 250 nm to less than 1 μm may also be referred to in the art as “sub-micron sized particles.” In other embodiments, the average particle size may be greater than or equal to 1 μm, specifically 1 to 25 μm. As used herein, “average particle size” and “average largest dimension” may be used interchangeably, and refer to particle size measurements based on number average particle size measurements, which may be routinely obtained by laser light scattering methods such as static or dynamic light scattering (SLS or DLS, respectively).

The nanoparticles can be of various shapes and dimensions, predominantly having a two-dimensional aspect ratio (i.e., ratios of length to width, at an assumed thickness; diameter to thickness; or surface area to cross-sectional area, for a plate-like nanoparticle such as nanographene or nanoclay) of greater than or equal to 10, specifically greater than or equal to 100, more specifically greater than or equal to 200, and still more specifically greater than or equal to 500. Similarly, the two-dimensional aspect ratio is less than or equal to 10,000, specifically less than or equal to 5,000, and still more specifically less than or equal to 1,000. Where the aspect ratio is greater for the plate-like nanoparticle, the barrier properties have been found to improve, where it is believed that higher aspect ratio favors a higher degree of alignment and overlap of the plate-like nanoparticle.

In an embodiment, the nanoparticle is graphene, sometimes referred to herein as nanographene where the average largest dimension is less than 1 μm. Unless otherwise specified, “graphenes” includes both graphene having an average largest dimension of greater than or equal to 1 μm, and nanographene having an average largest dimension of less than 1 μm. Graphenes, including nanographene, are effectively two-dimensional particles of nominal thickness, having a stacked structure of one or more layers of fused hexagonal rings with an extended delocalized π-electron system, layered and weakly bonded to one another through π-π stacking interaction. Graphenes including nanographene, may be a single sheet of graphite having a nano-scale dimension, and may in the case of nanographene have an average particle size (largest average dimension) of e.g., less than 1 μm, and more specifically a largest average dimension less than or equal to 500 nm, and still more specifically less than or equal to 250 nm. In other embodiments, the average particle size of the graphene may be greater than or equal to 1 μm, specifically 1 to 25 μm, more specifically 1 to 20 μm, still more specifically 1 to 10 μm. In an embodiment, the average diameter (average particle size) of a graphene is 0.5 to 5 μm, specifically 1 to 4 μm. Graphene has a nominal thickness of one or more carbon atoms thick, based on the number of layers, where a single layer (i.e., sheet) of graphene may theoretically have a thickness based on the approximate van der Waals radius of the carbon atom (i.e., about 1.6 to 1.7 angstroms). In other embodiments, graphenes have an average smallest particle size (smallest average dimension, i.e., thickness) in the nano-scale dimension of less than or equal to 50 nm, more specifically less than or equal to 25 nm, and still more specifically less than or equal to 10 nm. In an embodiment, a single sheet of a derivatized graphene may have a thickness of less than or equal to 5 nm.

Graphene, including nanographene, may be formed by exfoliation from a graphite source. In an embodiment, the nanographene is formed by exfoliation of graphite, intercalated graphite, and nanographite. Exemplary exfoliation methods include, but are not limited to, those practiced in the art such as fluorination, acid intercalation, acid intercalation followed by thermal shock treatment, and the like. Exfoliation of graphite or nanographite provides a graphene or nanographene having fewer layers than non-exfoliated graphite or nanographite. Graphite, including nanographite, may have a much greater thickness, than graphene. For example, nanographite may have a thickness dimension greater than 50 nm and less than or equal to 1 μm, specifically less than or equal to 500 nm, and still more specifically less than or equal to 300 nm. It will be appreciated that exfoliation of graphite or nanographite may provide the graphene or nanographene as a single sheet only one molecule thick, or as a layered stack of relatively few sheets (i.e., two or more). In an embodiment, exfoliated graphene (including nanographene) has less than 50 single sheet layers, specifically less than 20 single sheet layers, specifically less than 10 single sheet layers, and more specifically less than or equal to 5 single sheet layers.

The nanoparticles, including graphene or nanographene after exfoliation, can be derivatized to introduce chemical functionality on the surface and/or edges of the graphene sheet, to increase dispersibility in and interaction with various matrices including polymer resin matrix. Graphenes may be derivatized to include functional groups such as, for example, carboxy (e.g., carboxylic acid groups), epoxy, ether, ester, ketone, amine, hydroxy, alkyl, aryl, aralkyl including benzyl, lactone, other monomeric or polymeric groups including functionalized polymeric or oligomeric groups, and the like, and combinations comprising at least one of the foregoing groups. In an embodiment, the graphene is derivatized with positively charged groups and carries a net positive charge. For example, the graphene may subject to an amination reaction to include amine groups having a positive charge (upon reaction with an acid). In another embodiment, the graphenes can be derivatized with negatively charged groups to carry a net negative charge. For example, the graphene may be subject to an oxidative derivatization method to produce carboxylic acid functional groups having a negative charge (upon reaction with a base). In another embodiment, the graphenes can be further derivatized by grafting certain polymer chains which can carry either a negative or positive charge by adjusting the pH value of its aqueous solution. For example, polymer chains such as acrylic chains having carboxylic acid functional groups, hydroxy functional groups, and/or amine functional groups; polyamines such as polyethyleneamine or polyethyleneimine; and poly(alkylene glycols) such as poly(ethylene glycol) and poly(propylene glycol), may be included.

In this way, a first nanoparticle may have or be derivatized to have, for example, a positive charge and a second nanoparticle may have or be derivatized to have, for example, a negative charge. It will be appreciated that the first and second nanoparticles having either a positive or negative charge (or including either a positively or negatively charged functional group) have opposite charges. The first and second nanoparticles are then combined by disposing, by successive alternate layering, the first and second nanoparticles on a surface of a substrate. Preferably, the first (e.g., positively charged) and second (e.g., negatively charged) nanoparticles are positively and negatively charged derivatized graphenes, respectively. At least one functional group of the first derivatized nanoparticle is not identical to a functional group of the second derivatized nanoparticle. Multiple layers of the first and second derivatized nanoparticles may be included. The functional groups of the first and second derivatized nanoparticles are selected to adjust the nano-coating to be overall positively charged, negatively charged, neutrally charged, hydrophilic, hydrophobic, oleophilic, or oleophobic.

Thus, in an embodiment, the nano-coating includes multiple alternating layers of a first layer comprising a first nanoparticle having a positive or negative charge, and a second layer comprising a second nanoparticle having a positive or negative charge opposite that of the first nanoparticle. Each of the first and second nanoparticles has, in an embodiment, an aspect ratio greater than or equal to 10, and specifically, greater than or equal to 100. The nano-coating including the multiple alternating layers of first and second nanoparticles is disposed on a surface of a substrate. In an embodiment, the nano-coating consists essentially of alternating layers of the first and second nanoparticles, and may thus include less than 1% by weight of additives, based on the total weight of the nano-coating. In a more specific embodiment, the nano-coating consists of alternating layers of the first and second nanoparticles. The first and second nanoparticles are each derived from an identical or non-identical nanoparticle.

The nanoparticles may be applied as a solution or dispersion in a liquid medium such as oil, water, or an oil-water blend or emulsion, to form the nano-coating. In an embodiment, the first and second nanoparticles (such as for example derivatized graphenes that are positively charged and negatively charged) are each suspended in water as separate solutions, and applied by sequentially applying alternating layers of negatively and positively (or positively and negatively) charged nanoparticles. While not wishing to be bound by theory, it is believed that the functionality of a negatively charged nanoparticle, such as a negatively charged derivatized nanoparticle (e.g., carboxylic acid groups on a graphene), interact with complementary functionality on a positively charged nanoparticle, such as a positively charged derivatized nanoparticle (e.g., amino groups on graphene), to form an ion paired adduct. In this way, the first and second nanoparticles may be bonded together by an electrostatic force. It will also be appreciated that where functional groups are indicated to be of opposite charge (positive or negative), this may mean that the functionality may carry a full or partial positive, or full or partial negative, charge. Therefore, alternatively or in addition to interaction by electrostatic force as between groups carrying a full ionic charge (positive or negative), the oppositely charged functionality of derivatized groups can also attract to one another by dipole-dipole interactions, or by hydrogen bonding interactions as between, for example, carboxylic acid groups, amide groups, or the like. Thus, in an embodiment, the nanoparticles may be bonded together by electrostatic force, dipole-dipole interactions, hydrogen bonding, or a combination of these functional group interactions.

For example, a first graphene derivatized with carboxylic acid groups (or polymeric or oligomeric groups having carboxylic acid groups) and therefore negatively charged at a pH of greater than 7, may be disposed on a surface of a substrate. The first derivatized graphene may have an intrinsic charge opposite that of the surface of the substrate (such as where the composition of the substrate is for example polymeric and includes amino groups), or the substrate may be functionalized by a surface treatment (e.g., by corona or plasma treatment, or treatment with a coupling agent) or by application of a primer layer (e.g., a metal, ceramic, or polymeric coating) having a charge opposite the first derivatized graphene nanoparticle. The first derivatized graphene arranges on the substrate surface so as to distribute the net charge of the first derivatized graphene over as great a surface area of the substrate as possible, and in this way forms essentially a monolayer. A second graphene derivatized with amino groups (or polymeric or oligomeric groups having amine and/or imine functional groups) and positively charged at a pH of less than 7, is contacted to a surface of the first derivatized graphene disposed on the substrate.

The nano-coating may include alternating layers of oppositely charged nanoparticles alone, or a mixture of nanoparticles of the same net charge within each layer along with an additive(s). In an embodiment, the nanoparticle is suspended or dispersed in water to form a coating formulation. The nano-coating of the nanoparticles, after washing, drying and any post-processing such as curing, cross-linking, annealing, or the like, may include the nanoparticle as either all or a predominant portion of the total solids of the nano-coating.

The nano-coating is thus formed by applying a coating formulation of the nanoparticles to the substrate to be coated, forming successive layers. Coating formulations may include a dispersion or solution of the derivatized nanoparticle in e.g., water, oil, or an organic solvent where the total solids of derivatized nanoparticle and any additive, may be from 0.1 to 16 wt %, specifically 0.2 to 15 wt %, more specifically 0.5 to 12 wt %, and still more specifically 1.0 to 10 wt %, based on the total weight of the coating formulation.

Exemplary solvents for dispersing the derivatized nanoparticles include water including buffered or pH adjusted water; alcohols, such as methanol, ethanol, propanol, isopropanol, butanol, t-butanol, octanol, cyclohexanol, ethylene glycol, ethylene glycol methyl ether, ethylene glycol ethyl ether, ethylene glycol butyl ether, propylene glycol, propylene glycol methyl ether, propylene glycol ethyl ether, cyclohexanol, and the like; polar aprotic solvents such as dimethylsulfoxide, N,N-dimethylformamide, N-methylpyrrolidone, gamma butyrolactone, and the like; and combinations of these. The coating formulation may also include additional components such as common fillers and/or other nanoparticles, and/or other additives such as dispersants including ionic and/or non-ionic surfactants, coupling agents such as silane coupling agents, or the like. In another embodiment, the nanoparticle is suspended in a solvent, where no additive is included.

In a preferred embodiment (where the nanoparticle is a derivatized nanoparticle having a negatively charged group), the solvent is water having a pH of greater than 7, specifically greater than or equal to 8, more specifically greater than or equal to 9, and still more specifically greater than or equal to 10. In another preferred embodiment (where the nanoparticle is derivatized nanoparticle having a positively charged group), the solvent is water having a pH of less than 7, specifically less than or equal to 6, more specifically less than or equal to 5, and still more specifically less than or equal to 4. The pH may be adjusted by inclusion of an acid or base such as, respectively, hydrochloric acid or an alkali metal hydroxide such as sodium or potassium hydroxide, ammonium hydroxide or alkylammonium hydroxides such as tetramethylammonium hydroxide, trimethylbenzylammonium hydroxide, or the like.

The nano-coating of the nanoparticle may be coated on a substrate surface by any suitable method such as, but not limited to, dip coating, spray coating, roll coating, spin casting, and the like. The nano-coating is then dried at ambient temperatures, or in an oven operating at elevated temperatures of greater than room temperature, specifically greater than or equal to 80° C., more specifically greater than or equal to 90° C., and still more specifically greater than or equal to 100° C. The nano-coating may further be cured to strengthen and provide a protective, solvent and abrasion resistant matrix, where curing may be a thermal cure; irradiation using ionizing or non-ionizing radiation including visible or ultraviolet light, e-beam, x-ray, or the like; chemical curing as by e.g., exposure to an active curing agent such as an acid or base; or the like; or a combination of these curing methods.

Multiple coatings of the same or a different composition can be deposited using successive, sequential depositions of layers of positively or negatively charged nanoparticles in the nano-coating. The multilayered nano-coating thus comprises multiple, successively applied (i.e., alternating) layers of nanoparticles having opposite charges (by having, for example, oppositely charged functional groups). In an exemplary embodiment, the nano-coating is a multilayered coating including alternating layers of oppositely charged derivatized graphenes.

It will be appreciated that individual layers of nanoparticles may be formed for each iteration of a coating process, e.g., where one iteration includes one dip coat in a solution of a first nanoparticle, then one dip coat in a second, oppositely charged nanoparticle, followed by washing, drying and/or curing.

Preferably, in an embodiment, the nanoparticle in each adjacent layer is a derivatized graphene. In another embodiment, the nanoparticles in the adjacent layers are different. In a further embodiment, where the nanoparticles are different, at least every other layer contains a derivatized graphene (either positively or negatively charged). It will be appreciated that any number of different permutations of these layered structures are possible, and that the foregoing are merely illustrative of the concept and are not to be considered exhaustive of the possible embodiments.

In a specific embodiment, the multilayered coating comprises greater than or equal to 20 nanoparticle layers, specifically greater than or equal to 40 nanoparticle layers, more specifically greater than or equal to 60 nanoparticle layers, and still more specifically greater than or equal to 80 nanoparticle layers.

The nano-coating may have a thickness less than or equal to 500 μm. In an embodiment, the nano-coating has a thickness of 0.01 to 500 μm, specifically 0.05 to 200 μm, more specifically 0.1 to 100 μm, and still more specifically 0.1 to 50 μm. In a more specific embodiment, the nanoparticle layers may each have a thickness of 0.1 to 100 nm, specifically 0.5 to 50 nm, more specifically 1 to 10 nm. Where the nano-coating exceeds about 500 μm, the flexibility of the nano-coating and adhesion to the underlying substrate may be affected, and may lead to crack propagation and ultimately adhesion failure, which would compromise the barrier properties of the nano-coating. Similarly, where the nano-coating is less than 0.1 μm in thickness, the barrier properties may be insufficient. For reasons such as these, it is desirable to keep the nano-coating as thin as possible while maintaining effectiveness as a barrier to diffusion and permeation.

Optionally, the nano-coating may be crosslinked to improve mechanical performance, by including a crosslinker in the coating formulations applied to form the nano-coating. Useful crosslinkers may include, for example, acid catalyzed crosslinkers such as those having methoxymethylene groups and including glycolurils, melamines, amides, and ureas; epoxy crosslinkers which may react with amines and carboxylic acids such as bisphenol A diglycidyl ether, epoxy-substituted novolac resins, poly(glycidyl (meth)acrylate) polymers and copolymers, poly(2,3-epoxycyclohexylethyl)(meth)acrylate-containing polymers and copolymers, and the like; and radically initiated crosslinkers such as ethylene di(meth)acrylate, butylenedi(meth)acrylate, trimethylolpropane tri(meth)acrylate, dipentaerythritol penta(meth)acrylate; bismaleimides; and the like, and combinations thereof, may be used. Suitable initiators may be included as necessary, where useful initiators may be selected by the skilled artisan. Other crosslinkers may include bifunctional (or tri-, or tetra-functional, etc.) compounds which can react with the functional groups on the derivatized nanoparticles, including silanes functionalized with carboxylic acid groups, amine groups, or epoxy groups.

The nano-coating is disposed on a substrate. Exemplary substrates include those comprising polymers and resins such as phenolic resins including those prepared from phenol, resorcinol, o-, m- and p-xylenol, o-, m-, or p-cresol, and the like, and aldehydes such as formaldehyde, acetaldehyde, propionaldehyde, butyraldehyde, hexanal, octanal, dodecanal, benzaldehyde, salicylaldehyde, where exemplary phenolic resins include phenol-formaldehyde resins; epoxy resins such as those prepared from bisphenol A diepoxide, polyether ether ketones (PEEK), bismaleimides (BMI), nylons such as nylon-6 and nylon 6,6, polycarbonates such as bisphenol A polycarbonate, polyurethanes, nitrile-butyl rubber (NBR), hydrogenated nitrile-butyl rubber (HNBR), high fluorine content fluoroelastomers rubbers such as those in the FKM family and marketed under the tradename VITON® (available from FKM-Industries) and perfluoroelastomers such as FFKM (also available from FKM-Industries) and also marketed under the tradename KALREZ® perfluoroelastomers (available from DuPont), and VECTOR® adhesives (available from Dexco LP), organopolysiloxanes such as functionalized or unfunctionalized polydimethylsiloxanes (PDMS), tetrafluoroethylene-propylene elastomeric copolymers such as those marketed under the tradename AFLAS® and marketed by Asahi Glass Co., ethylene-propylene-diene monomer (EPDM) rubbers, polyethylene, polyvinylalcohol (PVA), and the like. In addition, the substrate may be a metallic or metal-clad substrate, where the metal is iron, steel, chrome alloys, hastelloy, titanium, molybdenum, and the like, or a combination comprising at least one of the aforementioned.

The substrate may be left untreated, or may be surface treated prior to deposition of the coating containing the nanoparticle, or prior to deposition of a binder layer or primer layer, followed by the nanoparticle coating. Surface treating of the substrate may be effected by a known method such as, for example, corona treatment, plasma treatment, chemical vapor treatment, wet etch, ashing, primer treatment including polymer based primer treatment or organosilane treatment, or the like. In an exemplary embodiment, the surface of the substrate is treated by corona treatment prior to deposition of the nano-coating.

A primer layer comprising a monomeric or polymeric material may be applied to a substrate to be coated to provide a surface of sufficient polarity for attachment of the nanoparticles. Definitionally, a primer layer is a layer only providing for a surface having the desired charge, whereas a binder layer may also further form an adhesive, covalent bond with and between each of the nanoparticle and the underlying substrate. The primer or binder may comprise an ionic molecule, an oligomer or polymer, or a combination comprising at least one of the foregoing. An exemplary primer includes those manufactured by Lord Adhesives and marketed under the tradename CHEMLOK®. In another embodiment, the surface of the substrate may be pretreated by dipping the substrate in an organosilane primer to form the primer layer prior to deposition of the nano-coating.

Thus, the nano-coating may include a primer layer applied to the substrate prior to coating of the nanoparticle layers, where the charge of the primer layer is opposite that of the first applied nanoparticle layer. In another embodiment, a second nanoparticle layer comprises a different nanoparticle such as a derivatized or non-derivatized carbon nanotube and/or a combination of nanoparticles.

The nano-coating so prepared has a unique combination of small average nanoparticle size (e.g., an average diameter of less than 5,000 nm where graphene is used) and specific physical properties such as impermeability, environmental stability, and thermal and electronic properties. In many respects, nanographene resembles polymer chains used as composite matrices, where both have covalently bonded structures, similar dimensions and mechanical flexibility. For example, graphenes have unique barrier properties and can conduct heat and electricity down the long axis of the graphene with an efficiency approaching that of metals such as copper and aluminum. A layered structure of a derivatized graphene is believed to act as an effective fluid barrier for a downhole element while allowing function of the element at a much higher temperature. Such a nano-coating is also believed to impart barrier properties which impedes diffusion and permeation of liquids such as hydrocarbon oil, water including both fresh water and brine, gases such as low molecular weight hydrocarbons (e.g., methane, ethane, propane, butanes, and the like), hydrogen sulfide, water vapor, and combinations of these liquids and/or gases.

The high (>10) aspect ratio nanoparticles including graphene exhibit a physical arrangement in the nano-coating by forming an interlocked barrier formed of overlapping, surface-aligned plate-like nanoparticles, which provide a tortuous diffusion pathway for any permeating compounds, and further provides a chemical impediment for diffusing molecules that is conceivably not possible to achieve with other traditional fillers such as clay, mica, carbon black, silicate, and the like due to either the lack of an overlapping plate-like morphology as in carbon black, or due to the more hydrophilic composition and structures of inorganic materials. In specific instances, the performance of a nano-coating and in particular, those containing derivatized graphene, can be further enhanced by, for example, coating the derivatized graphene with a metal or metal oxide coating. For example, where a metal coating is applied to a derivatized graphene used in the nano-coating, the diffusion of solute salts such as sodium chloride in water (brine) may be restricted, where the salts do not crystallize at the interface of the nano-coating and the substrate, but may be trapped on the high surface area on the metal coated derivatized graphene particles. In this way, the derivatized nanoparticles (i.e., including derivatized graphene) can be further adjusted or enhanced to provide additional desirable properties including barrier properties for ionic solutes, and may also enhance other properties such as electrical conductivity.

A method of forming the nano-coating includes disposing a nano-coating layer comprising a nanoparticle (e.g., graphene) on a substrate. The substrate may further be surface treated, for example, by corona treatment, or by deposition of an adhesion layer, to enhance adhesion and/or dispersion of the nanoparticle on the surface of the substrate. The nano-coating may include a derivatized or non-derivatized nanoparticle alone or in combination, and may be cured to crosslink by direct bond forming between the nanoparticles. The binder and nanoparticle layers may be post-treated with crosslinkers and/or with a high temperature postcure, to further crosslink and cure the nano-coating. In an embodiment, the method comprises depositing multiple alternating layers of positively charged nanoparticles and negatively charged nanoparticles. The alternating structure may be repeated until a layer having desirable thickness and physical properties (barrier property, abrasion resistance, etc.) is formed.

In an embodiment, the substrate is surface treated before deposition of the first nanoparticle. In another embodiment, each layer of nanoparticle may include more than one nanoparticle, e.g., where more than one kind of nanoparticle is used, for example, a derivatized graphene and a different nanoparticle such as a derivatized graphene derivatized to have different functional groups, a derivatized carbon nanotube, a nanoclay, or the like, etc., and/or where the nanoparticles in any given layer are different shapes and/or sizes; provided each derivatized nanoparticle has functional groups having the same net charge (positive or negative) within each layer of the multilayered nano-coating. In addition, a further nanoparticle layer having different physical properties may be applied as a surface layer. One or more such surface layers may be included, where the surface layers may comprise different nanoparticles and/or may be functionalized to have, in addition to the positively or negatively charged functional group, an additional functional group imparting a surface property other than a charge, such as for example, a fluorinated alkyl group to provide a hydrophobic surface to the surface layer.

The nano-coatings can be applied in part or completely to articles, and in particular different downhole elements. Various elements which may be coated with the nano-coating include, for example, a packer element, a blow out preventer element, a torsional spring of a sub surface safety valve, a submersible pump motor protector bag, a blow out preventer element, a sensor protector, a sucker rod, an O-ring, a T-ring, a gasket, a pump shaft seal, a tube seal, a valve seal, a seal for an electrical component, an insulator for an electrical component, a seal for a drilling motor, or a seal for a drilling bit.

The article is wholly or partially coated with the nano-coating. When coated with the nano-coating, these articles and elements may have improved resistance to permeation relative to uncoated elements, or to elements coated with polymer and/or standard filler-containing coatings that do not include nanoparticles such as graphene. The nano-coated articles can be used under challenging conditions such as those experienced in undersea or sub-terrain applications.

An example of an application in a sub-terrain environment is where an element used in a downhole application is exposed to severe conditions due to the presence of corrosive gases such as hydrogen sulfide, and other gases and chemicals. Where the element, such as for example a packer element, has a nano-coating as disclosed herein, the nano-coated element can demonstrate permeation selectivity, i.e., can preferentially impede water diffusion over diffusion of oil (hydrocarbon) components. The nano-coating can, in this way, also aid filtration and may be useful in a membrane or filter separation application. The permeation, barrier or diffusion properties can be selected for by choice of the type and properties of nanoparticle, its blend components, and the deposition techniques. Another advantage of an article or element having a coating based on nanoparticles is its efficacy in high temperature (e.g., greater than 100° C.) and/or high pressure (greater than 1 bar) environments, due to the robustness of the nanoparticles (e.g., graphene), under these conditions.

The nano-coatings are further described with reference to the following exemplary embodiments shown in the figures.

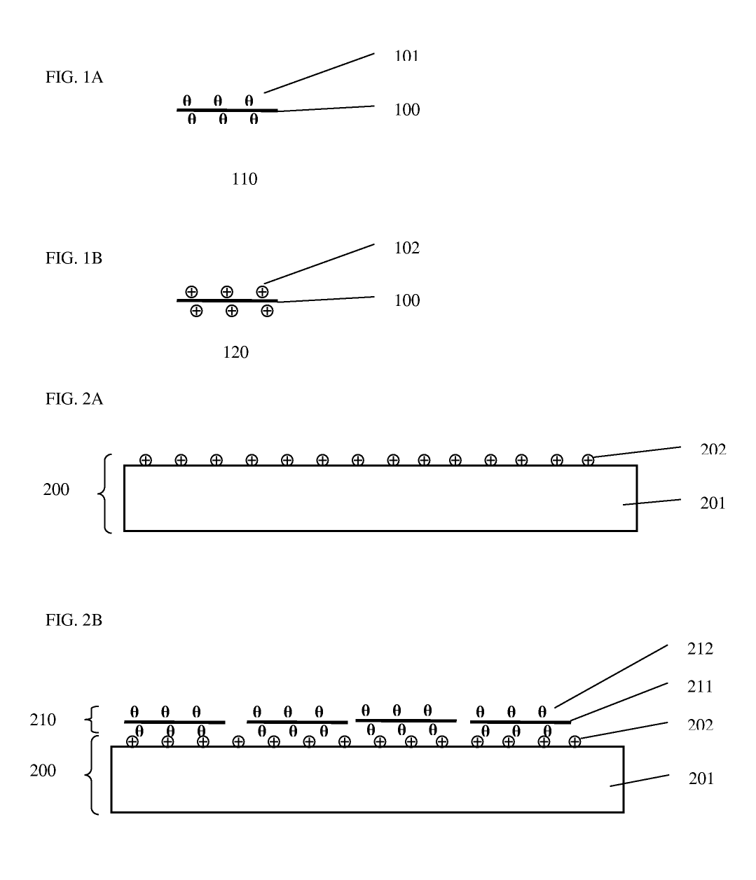

FIG. 1 shows schematic cross-sectional representations of a negatively charged nanoparticle 110 in which the nanoparticle 100 has negative charges 101. Similarly, in FIG. 1B, a positively charged nanoparticle 120 is illustrated, the nanoparticle 100 having positive charges 102. In an exemplary embodiment, the nanoparticle is a derivatized graphene with functional groups having positive or negative charges.

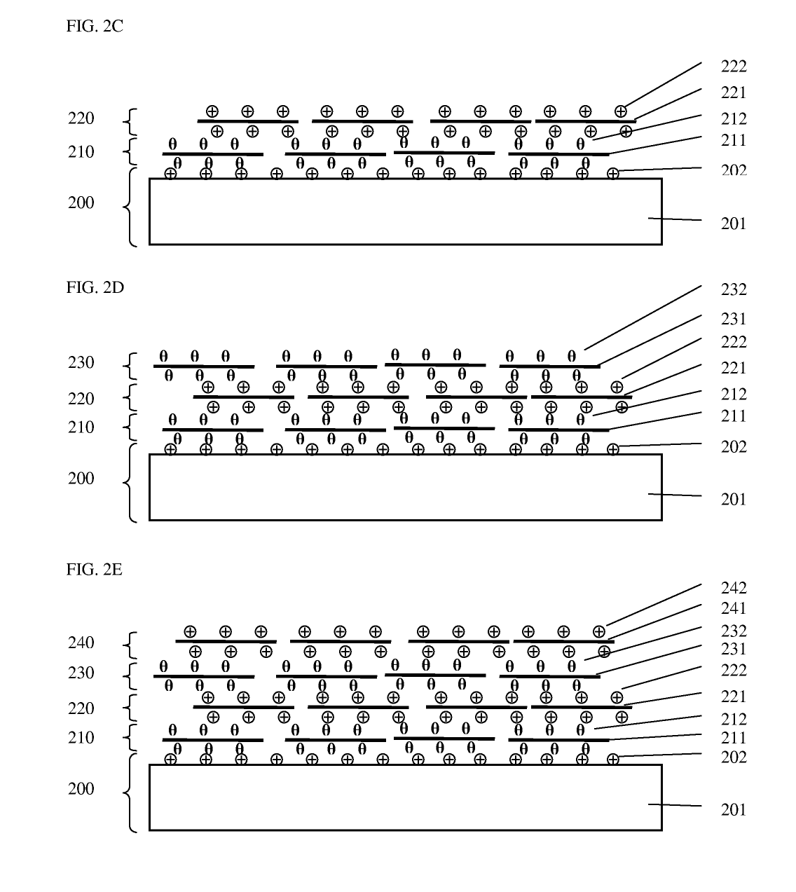

FIGS. 2A to 2E illustrate an exemplary layer-by-layer process for fabricating the nano-coating. FIG. 2A shows a substrate 200 where the substrate 200 is composed of a substrate material 201 having, in an exemplary embodiment, a positive or partial positive surface charge 202. In other embodiments, not shown but for purposes of emphasizing the versatility of the process, the charge may be a negative or partial negative charge. The surface charge may be present on the substrate by the intrinsic composition of the substrate material 201, where for example the substrate material 201 includes negatively charged groups such as carboxylic acids, or where the substrate material includes positively charged groups such as amine groups. In other embodiments, the substrate surface is treated with a surface treatment such as a silane, a polymer binder layer, or may be treated by corona treatment or by other ionizing radiation.

FIG. 2B shows the arrangement of negatively charged (212) nanoparticles 211 in a layer 210 disposed on a surface of substrate 200. The negative charges 212 of negatively charged nanoparticles 211 are oriented to the positive charges 202 on the surface of the positively charged substrate material 201. “Oriented”, “orienting” and “orient”, as used herein, refer to self-arrangement of the nanoparticles on the underlying oppositely charged surface (substrate, derivatized nanoparticle layer, etc.) to maximize the contacting surfaces so that the largest average dimension (e.g., the x-y plane, length and width, of a derivatized graphene) of the nanoparticle is coplanar with the underlying surface, and so that the net charge of the charged nanoparticle is distributed over as great an area of the underlying oppositely charged surface (substrate, nanoparticle layer, etc.) as possible, thus maximizing the electrostatic interactions (and hence bonding) between the nanoparticle and the underlying surface. Here, the negatively charged nanoparticles 211 may be applied by dip coating positively charged substrate 200 in a solution of negatively charged nanoparticles 211. The solution may be aqueous or non-aqueous based. In an embodiment, the nanoparticles (positively or negatively charged) are suspended in organic solvent, or in a pH buffered aqueous solution.

FIG. 2C shows the arrangement of positively charged (222) nanoparticles 221 in a layer 220 disposed on a surface of the layer 210 of negatively charged nanoparticle 211. The positively charges (222) of the nanoparticles 221 are preferably oriented to the negative charges 212 on the surface of the negatively charged nanoparticles 211 where, for example, the nanoparticles are derivatized to have charged functional groups with localized charge.

FIG. 2D shows the arrangement of negatively charged (232) nanoparticles 231 in a layer 230 disposed on a surface of the layer 220 of positively charged nanoparticles 221. The negative charges 232 of nanoparticles 231 are preferably oriented to the positive charges 212 on the surface of the positively charged nanoparticles 221.

FIG. 2E shows the arrangement of positively charged (242) nanoparticles 241 in a layer 240 disposed on a surface of the layer 230 of negatively charged nanoparticle 231. The positively charges (242) of the nanoparticles 241 are preferably oriented to the negative charges 232 on the surface of the negatively charged nanoparticles 231.

In FIGS. 2B to 2E, the negatively charged nanoparticles (211, 231) may be applied by dip coating of the positively charged substrate 200 (or in a subsequent coating step in FIG. 2C, the substrate 200 coated with negatively charged layer 210 and positively charged layer 220) in a solution of negatively charged nanoparticles (211, 231). Arrangement of the nanoparticles in a layer may be, as illustrated in the foregoing embodiments, a succession of monolayers (e.g., where each of layers 210, 220, 230, 240, etc. in FIGS. 2B to 2E comprises a single thickness of nanoparticle). In an embodiment, not shown, further alternating layers of negatively charged nanoparticles (e.g., 211, 231) and positively charged nanoparticles (e.g., 221, 241) may be added to the structure to achieve a desired thickness and/or number of layers of nanoparticles. In an embodiment, the total combined number of layers of negatively and positively charged nanoparticles is at least 20. In an embodiment, combinations of nanoparticles may be used, such as combinations of derivatized graphenes and derivatized nanotubes. In other embodiments, negatively charged nanoparticles (e.g., 211, 231) and positively charged nanoparticles (e.g., 221, 241) are not identical, i.e., the nanoparticle from which both sets of nanoparticles (positively and negatively charged) are prepared are not the same. In other embodiments, two or more different positively charged nanoparticles and/or two or more negatively charged nanoparticles may be used, where the nanoparticles are applied in layers forming a repeating alternating pattern for each layer, for every second layer, every third layer, etc. It will be appreciated that numerous possible combinations exist and there is no particular limitation to the pattern of applied layers; for example, where A is a first layer comprising a charged nanoparticle, and B is a second layer comprising an oppositely charged nanoparticle, the layers may be applied in order A, B, A, B, etc as in FIGS. 2A to 2E; or where additionally A′ is a third layer having the same charge as the nanoparticle in layer A but is based on a different nanoparticle or combination of nanoparticles, and/or B′ is a fourth layer having the same charge as the nanoparticle in layer B but is based on a different nanoparticle or combination of nanoparticles, the layers may be applied A, B, A′, B, A, B, A′ . . . etc.; or A, B, A′, B′, A, B, A′, B′, etc; or A, B, A, B, . . . A′, B′, A′, B′, etc. Any and all such permutations of combinations of layers and nanoparticles are contemplated herein.

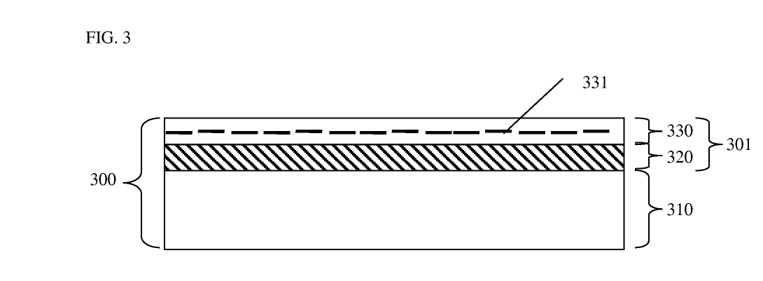

Also in an embodiment, shown in FIG. 3, a coated substrate 300 comprising the nano-coating 301 includes an additional layer or layers 330 of nanoparticles 331 derivatized to have other properties, such as, as desired, low surface energy, high surface energy, thermal and/or abrasion resistance (as by, for example, application of one or more layers of derivatized nanodiamond), etc., as a topmost (e.g., final or finish) layer. Finish layer 330 is applied to a surface of multilayered coating 320 comprising multiple layers (at least 20; not shown) of oppositely charged nanoparticles, disposed on a surface of substrate 310.

Also as shown in FIGS. 2B to 2E, the individual negatively charged nanoparticles (211, 231) do not align in perfect stacks with the nanoparticles above and below in the multilayered structure, but rather, align along the x-y plane (i.e., predominantly along the surface plane of the substrate) while overlapping along the z (thickness) axis. In this way, successive layers of in particular plate-like nanoparticles, such as derivatized particles of graphene and nanographene, exfoliated nanoclays, etc., randomly cover gaps between nanoparticles in underlying layers, so that only an indirect path between the nanoparticles exists. A multilayered nano-coating structure, formed in this way, thus advantageously provides a tortuous, indirect diffusion path along the z (thickness) axis of the nano-coating, and hence has low permeability to diffusible components.

A nano-coating of nanoparticles either alone or with minimal additive, as illustrated above, is believed to have a greater thermal decomposition and dimensional stability than a comparable multilayered structure comprising a combination of nanoparticles bonded through, for example, binder layers interleaved with the nanoparticle layers.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All ranges disclosed herein are inclusive of the endpoints, and the endpoints are independently combinable with each other. The suffix “(s)” as used herein is intended to include both the singular and the plural of the term that it modifies, thereby including at least one of that term (e.g., the colorant(s) includes at least one colorants). “Optional” or “optionally” means that the subsequently described event or circumstance can or cannot occur, and that the description includes instances where the event occurs and instances where it does not. As used herein, “combination” is inclusive of blends, mixtures, alloys, reaction products, and the like. All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

1. A nano-coating, comprising:
multiple alternating layers of
a first layer comprising a first nanoparticle having an aspect ratio greater than or equal to 10 and having a positive or negative charge, and
a second layer comprising a second nanoparticle having an aspect ratio greater than or equal to 10 and having a positive or negative charge opposite that of the first nanoparticle,
wherein the nano-coating is disposed on a surface of a substrate.

2. The nano-coating of claim 1, wherein the first and second nanoparticles are bonded together by electrostatic force dipole-dipole interactions, hydrogen bonding, or a combination of these.

3. The nano-coating of claim 1, wherein the aspect ratio of the first nanoparticle, second nanoparticle, or both the first and second nanoparticles is greater than or equal to 100.

4. The nano-coating of claim 1, wherein an average particle size of each of the first and second nanoparticle is 0.5 to 5 micrometers.

5. The nano-coating of claim 1, wherein a thickness of the nano-coating is 0.01 to 50 micrometers.

6. The nano-coating of claim 1, wherein the first and second nanoparticles are each derived from an identical or non-identical nanoparticle.

7. The nano-coating of claim 1, wherein the first and second nanoparticles are each independently derived from nanographite, graphenes, graphene oxide, fullerenes, nanotubes, nanodiamonds, nanoclays, polysilsesquioxanes, or combinations comprising at least one of the foregoing.

8. The nano-coating of claim 1, wherein the first nanoparticle is derived from nanographite, graphenes, graphene oxide, fullerenes, nanotubes, nanodiamonds, nanoclays, polysilsesquioxanes, or combinations comprising at least one of the foregoing.

9. The nano-coating of claim 1, wherein the second nanoparticle is derived from nanographite, graphenes, graphene oxide, fullerenes, nanotubes, nanodiamonds, nanoclays, polysilsesquioxanes, or combinations comprising at least one of the foregoing.

10. The nano-coating of claim 1, wherein the first and second nanoparticle are each derivatized to have functional groups including carboxy, epoxy, ether, ester, ketone, amine, hydroxy, alkoxy, alkyl, aryl, aralkyl, lactone, functionalized polymeric or oligomeric groups, or a combination comprising at least one of the forgoing functional groups, and at least one functional group of the first derivatized nanoparticle is not identical to a functional group of the second derivatized nanoparticle.

11. The nano-coating of claim 10, wherein the functional groups of the first and second derivatized nanoparticles are selected to adjust the nano-coating to be positively charged, negatively charged, neutrally charged, hydrophilic or hydrophobic, oleophilic, or oleophobic.

12. The nano-coating of claim 1, wherein the substrate comprises fluoroelastomers, perfluoroelastomers, hydrogenated nitrile butyl rubber, ethylene-propylene-diene monomer (EPDM) rubber, silicones, epoxy, polyetheretherketone, bismaleimide, polyethylene, polyvinylalcohol, phenolic resins, nylons, polycarbonates, polyurethanes, tetrafluoroethylene-propylene elastomeric copolymers, iron, steel, chrome alloys, hastelloy, titanium, molybdenum, or a combination comprising at least one of the foregoing.

13. The nano-coating of claim 1, wherein the nano-coating further comprises a surface layer comprising a third nanoparticle not identical to the first and second nanoparticles.

14. The nano-coating of claim 1, wherein the substrate is untreated, or is treated by corona treatment, organosilane treatment, polymer-based primer treatment, or a combination comprising at least one of the foregoing treatments.

15. A coated article comprising the nano-coating of claim 1.

16. The article of claim 15, wherein the article is a downhole element.

17. A nano-coating for an article, comprising:
multiple alternating layers of
a layer comprising positively charged graphene particles having an aspect ratio greater than or equal to 10, and
a layer comprising negatively charged graphene particles having an aspect ratio greater than or equal to 10,
wherein the nano-coating is disposed on a surface of the article.

18. A method of forming a nano-coating on an article, comprising:
depositing multiple alternating layers of
a first layer comprising a first nanoparticle having an aspect ratio greater than or equal to 10 and having a positive or negative charge; and
a second layer comprising a second nanoparticle having an aspect ratio greater than or equal to 10 and having a positive or negative charge opposite that of the first nanoparticle, on a surface of the first layer opposite the substrate.

19. The method of claim 17, wherein the depositing comprises film casting, spin coating, dip coating, spray coating, layer-by-layer coating, or a combination comprising at least one of the forgoing.

20. The method of claim 17, where the nanoparticle is derivatized to include a functional group comprising carboxy, ester, epoxy, ether, ketone, amine, hydroxyl, alkoxy, alkyl, aryl, aralkyl, lactones, functionalized polymeric or oligomeric groups, or a combination comprising at least one of the forgoing functional groups, and at least one functional group of the first derivatized nanoparticle is not identical to a functional group of the second derivatized nanoparticle.

21. The method of claim 17, wherein the nanoparticle is a graphene exfoliated from a graphite by fluorination, acid intercalation, acid intercalation followed by thermal shock treatment, or a combination comprising at least one of the foregoing.

22. The article of claim 17, wherein the article is a downhole element.

23. The method of claim 17, wherein the article is wholly or partially coated with the nano-coating.
